(19) United States
(12) Patent Application Publication
(10) Pub. No.: US 2015/0115862 A1
(43) Pub. Date: Apr. 30, 2015

(54) MOTOR CONTROL APPARATUS AND MOTOR SYSTEM

(71) Applicant: KABUSHIKI KAISHA YASKAWA DENKI, Kitakyushu-shi (JP)

(72) Inventors: Noor Aamir BALOCH, Kitakyushu-shi (JP); Kozo IDE, Kitakyushu-shi (JP); Shinya MORIMOTO, Kitakyushu-shi (JP)

(73) Assignee: KABUSHIKI KAISHA YASKAWA DENKI, Kitakyushu-shi (JP)

(21) Appl. No.: 14/592,833

(22) Filed: Jan. 8, 2015

Related U.S. Application Data
(63) Continuation of application No. PCT/JP2012/067501, filed on Jul. 9, 2012.

(51) Int. Cl. G05B 13/04; G05B 11/42; H02P 23/12

(52) U.S. Cl. CPC G05B 13/04; H02P 23/12; G05B 11/42
USPC 318/561

(57) ABSTRACT

A motor control apparatus includes a position and speed estimator configured to output a new estimated motor position and an estimated motor speed based on a position estimation deviation that is a difference between an acquired motor position and an estimated motor position of a motor, and a controller configured to output a motor power command, which controls the motor, based on the estimated motor position, the estimated motor speed, and a position command. The position and speed estimator includes a motor model of the motor configured to output the estimated motor position and the estimated motor speed based on a predetermined calculation value, and a nonlinear compensator configured to output a compensation motor power based on the position estimation deviation to compensate an error of the motor model.

### CROSS-REFERENCE TO RELATED APPLICATION

The present application is a continuation application of International Application No. PCT/JP2012/067501, filed Jul. 9, 2012, the entire content of which is hereby incorporated by reference.

### BACKGROUND

1. Technical Field

The present disclosure relates to a motor control apparatus and a motor system.

2. Description of the Related Art

JP-A-10-262387 discloses a state estimator. The state estimator estimates a rotational speed and a rotational position of a rotating body from initial values of a given rotational speed and rotational position based on a model of the rotating body on which a control torque of a value detected by a control torque detector and a disturbance torque of an estimated value work.

### SUMMARY

A motor control apparatus includes a position and speed estimator configured to output a new estimated motor position and an estimated motor speed based on a position estimation deviation that is a difference between an acquired motor position and an estimated motor position of a motor, and a controller configured to output a motor power command, which controls the motor, based on the estimated motor position, the estimated motor speed, and a position command. The position and speed estimator includes a motor model of the motor configured to output the estimated motor position and the estimated motor speed based on a predetermined calculation value, and a nonlinear compensator configured to output a compensation motor power based on the position estimation deviation to compensate an error of the motor model.

### BRIEF DESCRIPTION OF THE DRAWINGS

FIG. 1 is a block diagram of a motor system according to an embodiment of the present disclosure;

FIG. 2 is a block diagram of a position and speed estimator of a motor control apparatus included in the motor system illustrated in FIG. 1;

FIG. 3 is a block diagram of an observer for describing a setting process of an observer gain of an observer corrector;

FIG. 4 is a block diagram of a nonlinear compensator of the motor control apparatus included in the motor system illustrated in FIG. 1;

FIG. 5A includes graphs when a load inertia is 0.1 times a motor inertia, in which (A) illustrates a position estimation error by a conventional motor control apparatus and (B) illustrates a position estimation error by the motor control apparatus included in the motor system illustrated in FIG. 1;

FIG. 5B includes graphs when the load inertia is 3 times the motor inertia, in which (A) illustrates a position estimation error by a conventional motor control apparatus and (B) illustrates a position estimation error by the motor control apparatus included in the motor system illustrated in FIG. 1; and

FIG. 5C includes graphs when the load inertia is 15 times the motor inertia, in which (A) illustrates a position estimation error by a conventional motor control apparatus and (B) illustrates a position estimation error by the motor control apparatus included in the motor system illustrated in FIG. 1.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A motor control apparatus according to an aspect of the present disclosure includes a position and speed estimator configured to output a new estimated motor position and an estimated motor speed based on a position estimation deviation that is a difference between an acquired motor position and an estimated motor position of a motor, and a controller configured to output a motor power command, which controls the motor, based on the estimated motor position, the estimated motor speed, and a position command. The position and speed estimator includes a motor model of the motor configured to output the estimated motor position and the estimated motor speed based on a predetermined calculation value, and a nonlinear compensator configured to output a compensation motor power based on the position estimation deviation to compensate an error of the motor model.

A motor system according to another aspect of the present disclosure includes the motor control apparatus, a motor controlled according to a motor power command output from the motor control apparatus, and a position acquirer configured to acquire a motor position of the motor.

According to the aspect of the present disclosure, a control system having robustness can be provided.

In the following, with reference to the accompanying drawings, an embodiment of the present disclosure will be described for providing better understanding of the present disclosure. It is noted that, in each drawing, depiction of the portion which is not relevant to the description may be omitted.

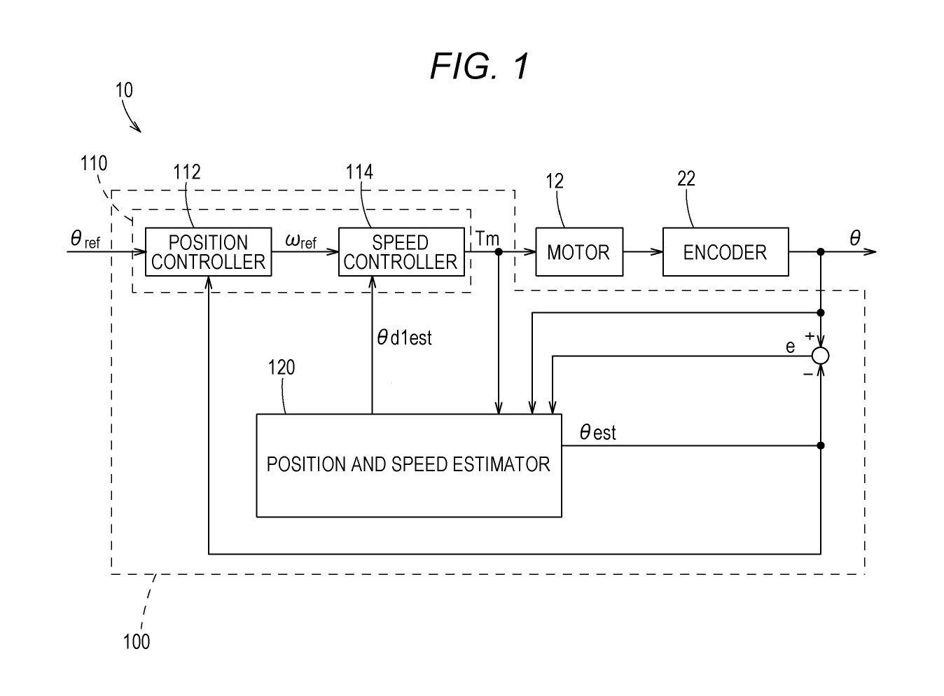

As illustrated in FIG. 1, a motor system 10 according to an embodiment of the present disclosure includes a motor 12, a motor control apparatus 100, and an encoder 22.

The motor 12 is a rotary motor, for example.

The motor control apparatus 100 is connected to the motor 12 and is able to output a torque command Tm for controlling the motor 12 based on a position command θref set by a user.

The encoder (an example of a position acquirer) 22 is able to acquire a rotational position (a motor position) of the motor 12. The encoder 22 is provided to a shaft of the motor 12, for example.

The position acquirer is not limited to the encoder, but may be a position estimation device that outputs an estimated position of the motor based on position sensor-less control (that may be also referred to as encoder-less control).

Next, the motor control apparatus 100 will be described in detail.

The motor control apparatus 100 includes a controller 110 and a position and speed estimator 120.

The controller 110 includes a position controller 112 and a speed controller 114, and is able to output the torque command Tm, which controls the motor 12, based on an estimated motor position Best that is an estimated position of the motor 12, an estimated motor speed θd1est that is an estimated speed of the motor 12, and the position command θref.

The position controller 112 is able to output a speed command ωref according to, for example, a P control calculation (a proportional control calculation) based on the position command θref and the estimated motor position Best output from the position and speed estimator 120.

The speed controller 114 is able to generate the torque command Tm according to a PI control calculation (a proportional integration control calculation) based on the speed command ωref output from the position controller 112 and the estimated motor speed θd1est output from the position and speed estimator 120.

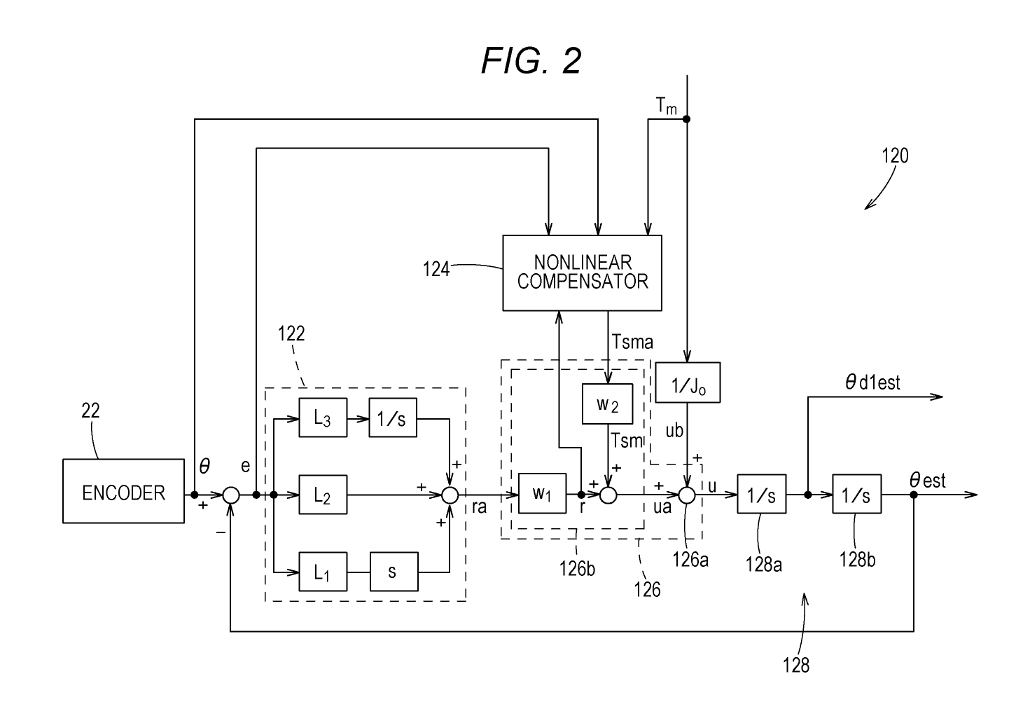

As illustrated in FIG. 2, the position and speed estimator 120 is able to output a new (corrected) estimated motor position Best and estimated motor speed θd1est based on a position estimation deviation e that is a difference between a motor position θ output from the encoder 22 (the acquired motor position θ) and the estimated motor position Best output from the position and speed estimator 120.

The position and speed estimator 120 includes an observer corrector 122, a nonlinear compensator 124, a calculator 126, and a motor model 128 that is a model of the motor 12.

The observer corrector 122 is able to output an observer correction value ra based on the position estimation deviation e. Specifically, the observer corrector 122 is able to output the observer correction value ra so as to reduce the position estimation deviation e to zero.

The observer corrector 122 is able to calculate the observer correction value ra according to a PID control calculation based on a value obtained by multiplying the position estimation deviation e by observer gains L₁, L₂, and L₃ determined by an observer cutoff frequency f, respectively, as indicated in the following formula. It is noted that s is a Laplace operator.

ra=L₃·e/s+L₂·e+L₁·e·s formula (1)

Here, an example of the setting process of the observer gains L₁ to L₃ will be described.

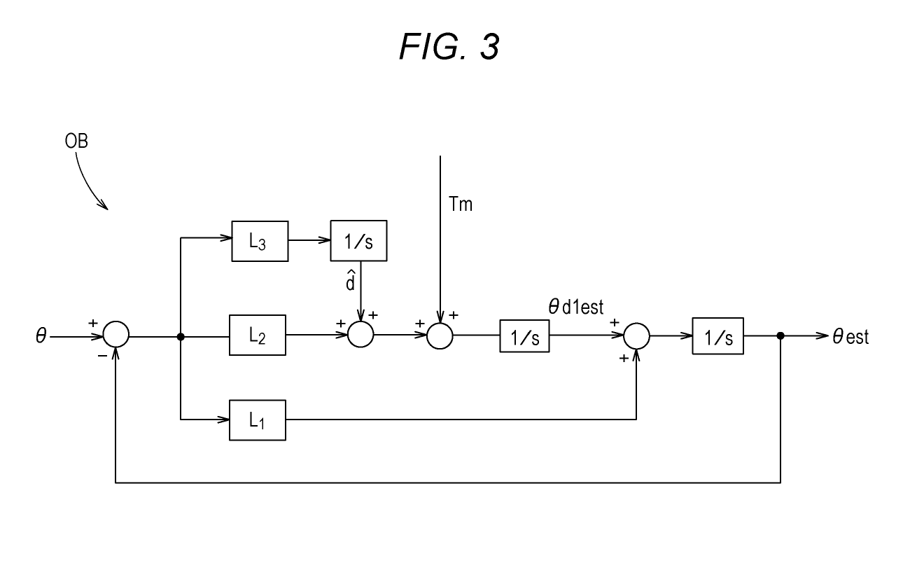

The observer gains L₁ to L₃ can be set based on an observer OB that estimates a motor position based on the motor position θ and the torque command Tm, as illustrated in FIG. 3, for example.

The state equation of the observer OB is expressed by the following formula.

$$\frac{d}{d t} [ \begin{matrix}θ est \\ θ d 1 est \\ \hat{d}\end{matrix} ] = [ \begin{matrix}0 & 1 & 0 \\ 0 & 0 & 1 \\ 0 & 0 & 0\end{matrix} ] \cdot [ \begin{matrix}θ est \\ θ d 1 est \\ \hat{d}\end{matrix} ] + [ \begin{matrix}0 \\ 1 \\ 0\end{matrix} ] Tm + [ \begin{matrix}{L}_{1} \\ {L}_{2} \\ {L}_{3}\end{matrix} ] ( θ - θ est ) \qquad formula ( OB 1 )$$

Here, matrices A, L, and C are defined as follows.

$$\begin{matrix}A = [ \begin{matrix}0 & 1 & 0 \\ 0 & 0 & 1 \\ 0 & 0 & 0\end{matrix} ] & formula ( OB 2 ) \\ L = [ \begin{matrix}{L}_{1} \\ {L}_{2} \\ {L}_{3}\end{matrix} ] & formula ( OB 3 ) \\ C = [ \begin{matrix}1 & 0 & 0\end{matrix} ] & formula ( OB 4 )\end{matrix}$$

It is noted that \hat{d} is an integrated value of the value output by the observer gain L₃, as illustrated in FIG. 3.

The characteristic equation is expressed by the following formula.

det|sI−(A−LC)|=0 formula (OB5)

When the pole of the characteristic equation is a triple pole ω, the following formula is obtained.

det|sI−(A−LC)|=(s+ω)³ formula (OB6)

After the formula (OB2) to the formula (OB4) are substituted for the formula (OB6) and simplified, the formula (OB12) is obtained via the formula (OB7) to the formula (OB11).

$$\begin{matrix}det \vert [ \begin{matrix}s & 0 & 0 \\ 0 & s & 0 \\ 0 & 0 & s\end{matrix} ] - [ \begin{matrix}0 & 1 & 0 \\ 0 & 0 & 1 \\ 0 & 0 & 0\end{matrix} ] + [ \begin{matrix}{L}_{1} \\ {L}_{2} \\ {L}_{3}\end{matrix} ] \cdot [ \begin{matrix}1 & 0 & 0\end{matrix} ] - \vert = {( s + ω )}^{3} & formula ( OB 7 ) \\ det \vert [ \begin{matrix}{L}_{1} + s & - 1 & 0 \\ {L}_{2} & s & - 1 \\ {L}_{3} & 0 & s\end{matrix} ] \vert = {( s + ω )}^{3} & formula ( OB 8 ) \\ ( {L}_{1} + s ) \vert \begin{matrix}s & - 1 \\ 0 & s\end{matrix} \vert + \vert \begin{matrix}{L}_{2} & - 1 \\ {L}_{3} & s\end{matrix} \vert = {( s + ω )}^{3} & formula ( OB 9 ) \\ ( {L}_{1} + s ) {s}^{2} + ( {L}_{2} s + {L}_{3} ) = {( s + ω )}^{3} & formula ( OB 10 ) \\ {L}_{1} {s}^{2} + {s}^{3} + {L}_{2} s + {L}_{3} = {( s + ω )}^{3} & formula ( OB 11 ) \\ {s}^{3} + {L}_{1} {s}^{2} + {L}_{2} s + {L}_{3} = {s}^{3} + 3 {s}^{2} ω + 3 s {ω}^{2} + {ω}^{3} & formula ( OB1 \; 2 )\end{matrix}$$

In the formula (OB12), in comparing the factors of the Laplace operator s, the observer gains L₁ to L₃ can be set as follows.

L₁=3ω formula (OB13)

L₂=3ω² formula (OB14)

L₃=ω³ formula (OB15)

It is noted that the pole ω is expressed by the following formula.

ω=2πf formula (OB16)

It is noted that f is the cutoff frequency of the observer OB described above.

The nonlinear compensator 124 is able to improve the robustness of the control system by compensating the position or the speed of the motor 12 when the encoder 22 is of low resolution, for example. Further, the nonlinear compensator 124 is able to improve the robustness of the control system by compensating a controlled object model error (a variation error) in the observer OB that compensates a speed detection error in a low speed range.

The nonlinear compensator 124 is able to output a compensation torque Tsma based on the position estimation deviation e, as illustrated in FIG. 2.

In details, the nonlinear compensator 124 is input with the motor position 0, the position estimation error e, the torque command Tm, and a product r obtained by multiplying the observer correction value ra by a first weighting factor w₁ and is able to calculate the compensation torque Tsma depending on at least the polarity change of the product r.

The design process (configuration) and the specific calculation for outputting the compensation torque Tsma in the nonlinear compensator 124 will be described later.

The calculator 126 is able to output an input value u to the motor model 128 of the motor 12 based on the observer correction value ra, the compensation torque Tsma, and a divided value ub described later.

The calculator 126 has an addition distributor 126b and an adder 126a.

The addition distributor 126b is able to add the observer correction value ra and the compensation torque Tsma based on an addition distribution determined by using weighting factors w₁ and w₂ and to output the added result as an added value ua. The weighting factors w₁ and w₂ are, for example, the first weighting factor w₁ for the observer correction value ra and the second weighting factor w₂ for the compensation torque Tsma.

The adder 126a is able to add the added value ua and the divided value ub obtained by dividing the torque command Tm by an inertia nominal value J₀ of the motor 12 and output the calculated value (the added result) as the input value u.

That is, the input value u can be derived by the following formula (3a), formula (3b), and formula (3c).

u=ua+ub formula (3a)

where,

ua=w₁·ra+w₂·Tsma formula (3b)

ub=Tm/J₀ formula (3c)

Here, it is preferable that the first weighting factor w₁ is greater than the second weighting factor w₂. Specifically, it is preferable that the value of the first weighting factor w₁ is around two to three times the value of the second weighting factor w₂. For example, (w₁, w₂)=(0.6, 0.2), (w₁, w₂)=(0.5, 0.2), or (w₁, w₂)=(0.6, 0.3) can be applied. It is noted that the values of the first weighting factor w₁ and the second weighting factor w₂ are 0 or more and 1 or less.

It is noted that, in the following, the product r(=w₁·ra) represents the input value to the motor model 128 before compensated by the compensation torque Tsm. Therefore, the product r may be referred to as uncompensated motor model input.

The motor model 128 has two integrators 128a and 128b connected in series.

The integrator 128a is able to integrate the input value u to calculate the estimated motor speed θd1est and output it.

The integrator 128b is able to integrate the estimated motor speed θd1est to calculate the estimated motor position θest and output it.

That is, the motor model 128 is able to output the estimated motor position θest and the estimated motor speed θd1est based on the input value u output from the calculator 126.

Next, the design process of the nonlinear compensator 124 will be described.

The above-described motor model 128 is a model where friction is not taken into consideration. Accordingly, when the inertia nominal value J₀ of the motor 12 and the inertia of the actual motor 12 and load system are significantly different and when the friction is large, there is a likelihood that the correction of the input value u of the motor model 128 by the observer corrector 122 becomes insufficient. Therefore, in these cases, there is a likelihood that the position estimation deviation e makes hunting in the transient state and the convergence becomes slow.

Thus, in order to asymptotically stabilize the uncompensated motor model input r, an evaluation function V is defined as follows.

$$V = \frac{{J}_{0} {r}^{2}}{2} \qquad formula ( C 1 )$$

At this time, the necessary and sufficient condition for the uncompensated motor model input r to be asymptotically stabilized is represented as the following formula.

\dot{V}=J₀r\dot{r}<0 formula (C2)

Here, when the input value u of the motor model is expressed as the inverse model from the model output, it is represented as the following formula.

$$\begin{matrix}u = \ddot{\hat{θ}} + F \\ = \ddot{θ} - \ddot{e} + F\end{matrix} \qquad formula ( C 3 )$$

Here, the second derivative of the new variable Or is defined as follows. It is noted that Δθ=e=θ−θest.

\ddot{θ}ᵣ=L₃Δθ+L₂Δ\dot{θ}+L₁\ddot{θ} formula (C4)

The following formula is derived from the formula (C4).

Jₒ\dot{r}=−uw₁JₒL₁+w₁Jₒ\ddot{θ}ᵣ+Fw₁JₒL₁ formula (C5)

It is noted that F is a system disturbance.

Incidentally, as indicated in the formula (3a), the formula (3b), and the formula (3c) described above, the input value u of the motor model is the added value resulted by adding the added value ua, which is resulted by adding the uncompensated motor model input r (=w₁·ra) to the compensation torque Tsm (=w₂·Tsma) obtained by multiplying the compensation torque Tsma by the weighting factor w₂, to a divided value ub, which is obtained by dividing the torque command Tm by the inertia nominal value J₀ of the motor 12, and is expressed by the following formula.

u=w₁·ra+w₂·Tsma+Tm/J₀ formula (C5a)

Substitution of the input value u represented by the formula (C5a) for the formula (C5) results in the following formula.

$${J}_{o} \dot{r} = - {rw}_{1} {J}_{o} {L}_{1} + {w}_{1} {J}_{o} {L}_{1} ( \frac{{\ddot{θ}}_{r}}{{L}_{1}} - \frac{{T}_{m}}{{J}_{o}} + F - {w}_{2} {T}_{sma} ) \qquad formula ( C 6 )$$

Substitution of the formula (C6) for the formula (C2) results in the following formula.

$$\dot{V} = - {r}^{2} {w}_{1} {J}_{o} {L}_{1} + {rw}_{1} {J}_{o} {L}_{1} ( \frac{{\ddot{θ}}_{r}}{{L}_{1}} - \frac{{T}_{m}}{{J}_{o}} + F - {w}_{2} {T}_{sma} ) \qquad formula ( C 7 )$$

The first term on the right side of the formula (C7) is always negative. Therefore, one of the conditions for satisfying the following formula is that the second twin on the right side of (C7) is negative.

\dot{V}<0 formula (C8)

When the second term on the right side of (C7) is negative, the following formula is obtained.

$${rw}_{1} {J}_{o} {L}_{1} ( \frac{{\ddot{θ}}_{r}}{{L}_{1}} - \frac{{T}_{m}}{{J}_{o}} + F - {w}_{2} {T}_{sma} ) < 0 \qquad formula ( C 9 )$$

Accordingly, after the compensation torque Tsma is designed to satisfy the formula (9), the following formula is obtained.

$${T}_{sma} = signum ( r ) ( \vert \frac{{\ddot{θ}}_{r}}{{L}_{1 a}} - \frac{{T}_{m}}{{J}_{mm}} \vert + {F}_{max} ) \qquad formula ( C 10 a )$$

Here, Jmm=γ×J0(γ>0), γ denotes an adjustment parameter, Fmax denotes an expected maximum system disturbance value, and L₁ₐ denotes an adjustment gain.

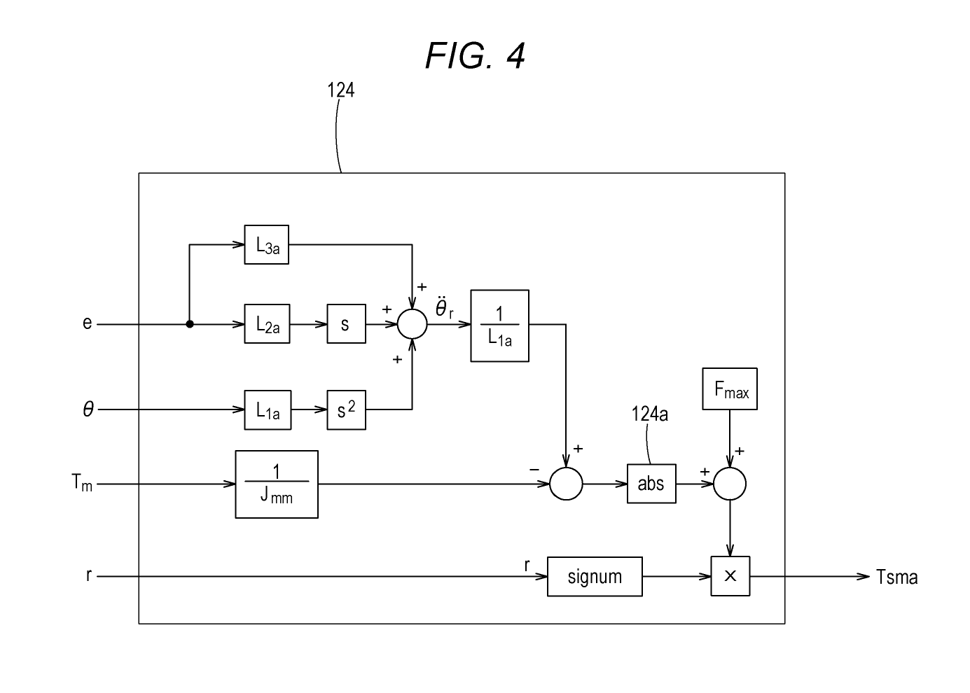

The nonlinear compensator 124 implementing the calculation indicated in the formula (C10a) is represented by a control block diagram illustrated in FIG. 4 with the use of the function 124a that outputs the absolute value of the input. It is noted that, in FIG. 4, it is preferable that the adjustment gains L₁ₐ to L₃ₐ are set as the same values as the observer gains L₁ to L₃, respectively. However, the adjustment gains L₁ₐ to L₃ₐ may be set to substantially the same magnitude as each other.

It is noted that the polarity of the formula (C10a) frequently changes depending on the polarity of the uncompensated motor model input r. Thus, a chattering phenomenon may occur. Therefore, in place of (C10a), the nonlinear compensator 124 may also use a function including a chattering reduction operator δ as represented in the following formula.

$${T}_{sma} = \frac{r}{δ + \vert r \vert} ( \vert \frac{{\ddot{θ}}_{r}}{{L}_{1 a}} - \frac{{T}_{m}}{{J}_{mm}} \vert + {F}_{max} ) \qquad formula ( C 10 b )$$

As discussed above, the nonlinear compensator 124 is designed so as to output the compensation torque Tsma based on the formula (C10a) or the formula (C10b), so that the compensation torque Tsm obtained by multiplying the compensation torque Tsma by the weighting factor w₂ can be obtained as indicated in the following formula (C11).

Tsm=w₂·Tsma formula (C11)

As described above, in the motor control apparatus 100, the position and speed estimator 120 includes the nonlinear compensator 124. Thus, according to the motor control apparatus 100, for example, the control system with the robustness can be provided even when the encoder having a lower resolution than the resolution for implementing a desired control performance or even when the position and speed control is made by the position sensor-less control. Further, the motor control apparatus 100 is able to configure the control system with the robustness even when the variation error of the parameter setting including the motor or load inertia or the load inertia occurs, for example.

That is, in the motor control apparatus 100, since the position and speed estimator 120 includes the nonlinear compensator 124, the error in the motor model 128 (that is, the errors of the motor position and the estimated motor speed output from the motor model 128) can be compensated. Thus, the motor control apparatus 100 is able to configure the control system with the robustness.

Next, the motor control apparatus 100 will be further described with reference to simulation examples. The load inertia of the motor 12 was set to 0.1 times, 3 times, or 15 times the motor inertia. In respective cases, the motor position and the position estimation error were obtained for a motor control apparatus having a conventional observer adapted to estimate the motor position and speed and for the motor control apparatus 100 of the present embodiment.

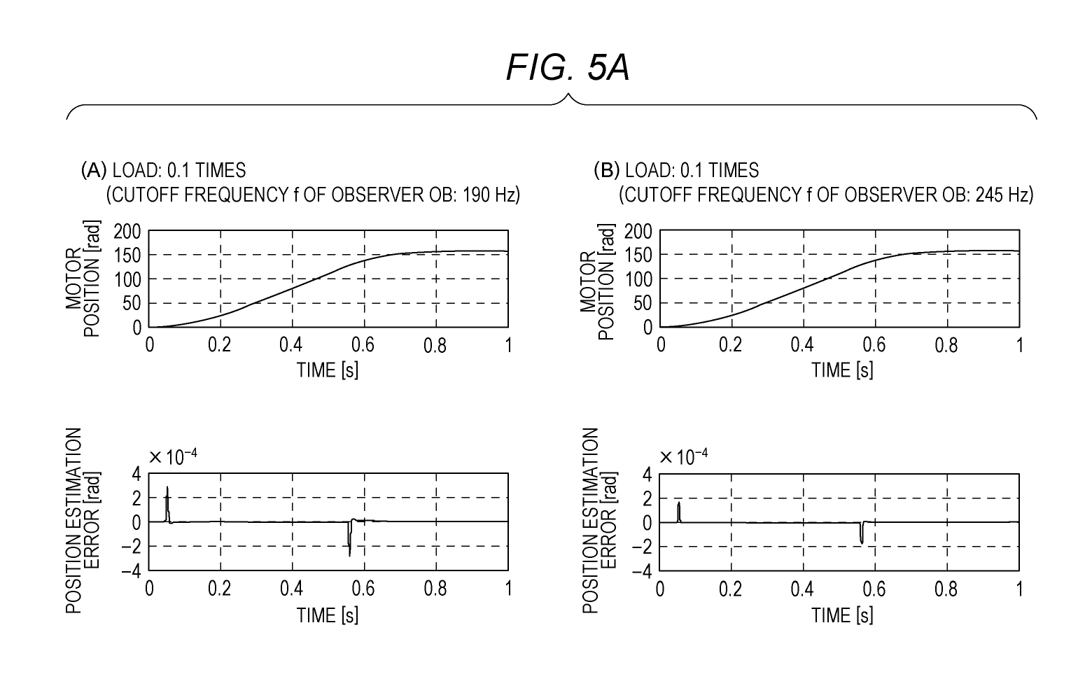

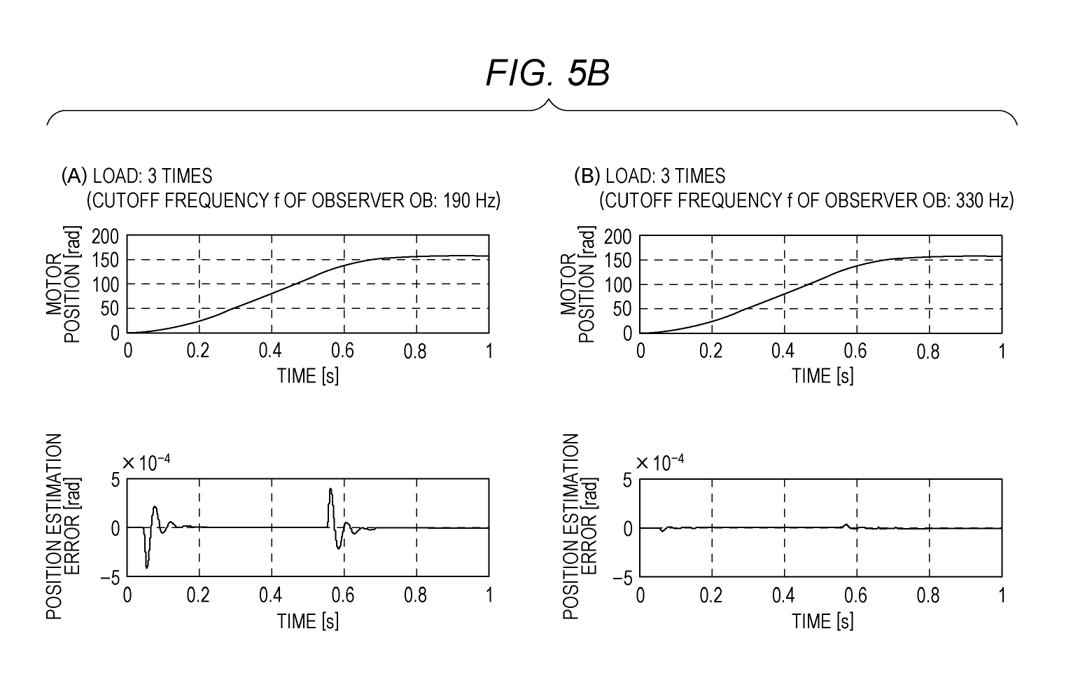

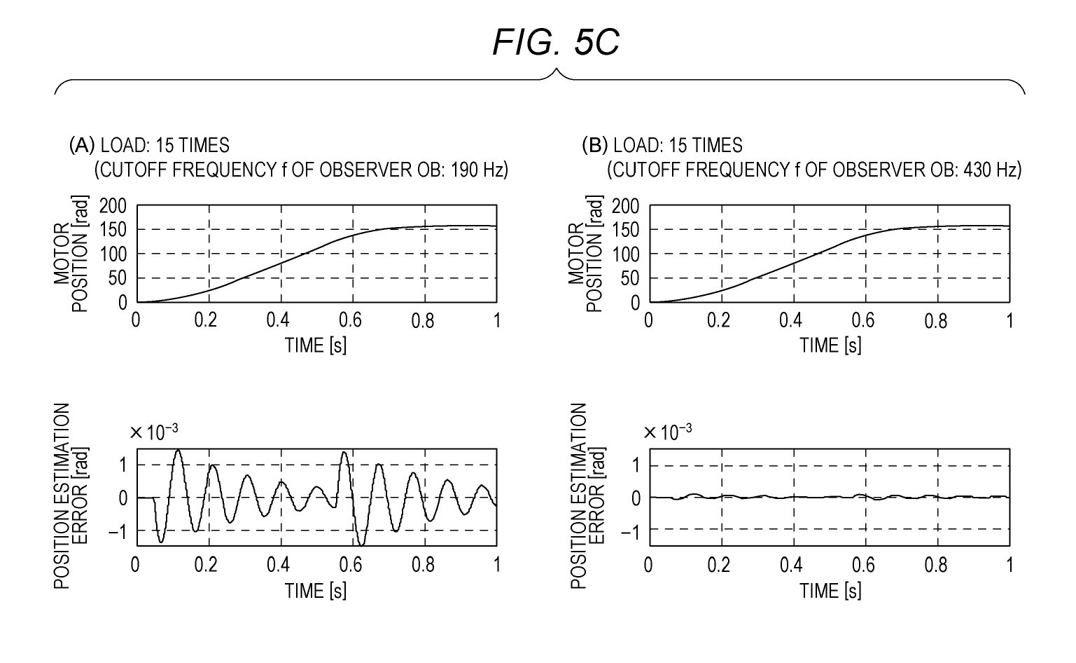

(A) of each of FIG. 5A to FIG. 5C includes graphs illustrating the motor position and the position estimation error obtained by the conventional motor control apparatus. On the other hand, (B) of each of FIG. 5A to FIG. 5C includes graphs illustrating the motor position and the position estimation error obtained by the motor control apparatus of the motor system 10 of the present embodiment. In the graph in the upper section of each figure, the horizontal axis represents time (s) and the vertical axis represents the motor position (rad). In the graph in the lower section of each figure, the horizontal axis represents the time (s) and the vertical axis represents the position estimation error (rad).

As is clear from FIG. 5A to FIG. 5C, according to the position and speed estimator 120 of the motor control apparatus 100, the position estimation error is reduced compared to the conventional one even when the load inertia varies.

The technique of the present disclosure is not limited to the above-described examples. Modifications without changing the spirit of the technique of the present disclosure are possible. For example, the configurations by the combination of a part of or all of the above-described examples and modified examples are also included in the technical scope of the present disclosure.

For example, the motor may be a linear motor. When the motor is the linear motor, the motor control apparatus according to the embodiment of the present disclosure can be provided based on consideration that the torque command, the rotational speed, the rotational position, and the compensation torque for the rotary motor are replaced with a thrust command, a moving speed, a moving position, and a compensation thrust for the linear motor. It is noted that each of the torque and the thrust is an example of the motor power. Each of the torque command and the thrust command is an example of the motor power command. Each of the compensation torque and the compensation thrust is an example of the compensation motor power.

It is noted that the position and speed estimator 120 is an example of the position and speed estimation means, the controller 110 is an example of the control means, and the nonlinear compensator 124 is an example of the nonlinear compensation means.

Further, the embodiment of the present disclosure may be the following first to seventh motor control apparatus and first motor system.

The first motor control apparatus includes: a position and speed estimator configured to, based on a position estimation deviation that is a difference between a motor position and an estimated motor position of a motor, output the estimated motor position and an estimated motor speed; and a controller configured to, based on the estimated motor position, the estimated motor speed, and a position command, output a torque command that controls the motor, wherein the position and speed estimator includes a nonlinear compensator configured to output a compensation torque based on the position estimation deviation and compensate an error of a motor model of the motor that outputs the estimated motor position and the estimated motor speed.

In the second motor control apparatus in the first motor control apparatus, the position and speed estimator further includes an observer corrector configured to output an observer correction value based on the position estimation deviation and a calculator configured to output a calculation value input to the motor model based on the observer correction value and the compensation torque.

In the third motor control apparatus in the second motor control apparatus, the calculator includes an addition distributor configured to add the observer correction value and the compensation torque based on an addition distribution determined by using a weighting factor and output it as an added value, and an adder configured to add the added value and a divided value resulted by dividing the torque command by an inertia nominal value of the motor and output it as the calculation value.

In the fourth motor control apparatus in the third motor control apparatus, the weighting factor includes a first weighting factor for the observer correction value and a second weighting factor for the compensation torque, and the first weighting factor is greater than the second weighting factor.

In the fifth motor control apparatus in the fourth motor control apparatus, the first weighting factor is two to three times the second weighting factor.

In the sixth motor control apparatus in the fourth or fifth motor control apparatus, the observer corrector multiplies the position estimation deviation by an observer gain determined by an observer cutoff frequency, and calculates the observer correction value by a PID control calculation.

In the seventh motor control apparatus in any one of the fourth to sixth motor control apparatus, the nonlinear compensator is input with the motor position, the position estimation deviation, the torque command, and a product resulted by multiplying the observer correction value by the first weighting factor and calculates the compensation torque depending on at least a polarity change of the product.

The first motor system includes: any one of the first to seventh motor control apparatus; a motor controlled according to a torque command output from the motor control apparatus; and a position acquirer configured to acquire a motor position of the motor.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A motor control apparatus comprising:
a position and speed estimator configured to output a new estimated motor position and an estimated motor speed based on a position estimation deviation that is a difference between an acquired motor position and an estimated motor position of a motor; and
a controller configured to output a motor power command, which controls the motor, based on the estimated motor position, the estimated motor speed, and a position command, wherein
the position and speed estimator includes
a motor model of the motor configured to output the estimated motor position and the estimated motor speed based on a predetermined calculation value, and
a nonlinear compensator configured to output a compensation motor power based on the position estimation deviation to compensate an error of the motor model.

2. The motor control apparatus according to claim 1, wherein
the position and speed estimator further includes
an observer corrector configured to output an observer correction value based on the position estimation deviation, and
a calculator configured to output the calculation value input to the motor model based on the observer correction value and the compensation motor power.

3. The motor control apparatus according to claim 2, wherein
the calculator includes
an addition distributor configured to add the observer correction value and the compensation motor power based on an addition distribution determined by using a weighting factor and output an added result as an added value, and
an adder configured to add the added value and a divided value obtained by dividing the motor power command by an inertia nominal value of the motor and output an added result as the calculation value.

4. The motor control apparatus according to claim 3, wherein the weighting factor includes a first weighting factor for the observer correction value and a second weighting factor for the compensation motor power, and the first weighting factor is greater than the second weighting factor.

5. The motor control apparatus according to claim 4, wherein the first weighting factor is two to three times the second weighting factor.

6. The motor control apparatus according to claim 4, wherein the observer corrector calculates the observer correction value according to a PID control calculation based on a value obtained by multiplying the position estimation deviation by an observer gain determined by an observer cutoff frequency.

7. The motor control apparatus according to claim 5, wherein the observer corrector calculates the observer correction value according to a PID control calculation based on a value obtained by multiplying the position estimation deviation by an observer gain determined by an observer cutoff frequency.

8. The motor control apparatus according to claim 4, wherein the nonlinear compensator is input with the acquired motor position, the position estimation deviation, the motor power command, and a product obtained by multiplying the observer correction value by the first weighting factor and calculates the compensation motor power depending on at least a polarity change of the product.

9. The motor control apparatus according to claim 5, wherein the nonlinear compensator is input with the acquired motor position, the position estimation deviation, the motor power command, and a product obtained by multiplying the observer correction value by the first weighting factor and calculates the compensation motor power depending on at least a polarity change of the product.

10. The motor control apparatus according to claim 6, wherein the nonlinear compensator is input with the acquired motor position, the position estimation deviation, the motor power command, and a product obtained by multiplying the observer correction value by the first weighting factor and calculates the compensation motor power depending on at least a polarity change of the product.

11. The motor control apparatus according to claim 7, wherein the nonlinear compensator is input with the acquired motor position, the position estimation deviation, the motor power command, and a product obtained by multiplying the observer correction value by the first weighting factor and calculates the compensation motor power depending on at least a polarity change of the product.

12. The motor control apparatus according to claim 1, wherein the motor is a rotary motor.

13. The motor control apparatus according to claim 1, wherein the motor is a linear motor.

14. A motor control apparatus comprising:
position and speed estimation means for outputting a new estimated motor position and an estimated motor speed based on a position estimation deviation that is a difference between an acquired motor position and an estimated motor position of a motor; and
control means for outputting a motor power command, which controls the motor, based on the estimated motor position, the estimated motor speed, and a position command, wherein
the position and speed estimation means includes
nonlinear compensating means for compensating errors in the estimated motor position and the estimated motor speed by a compensation motor power based on the position estimation deviation.

15. A motor system comprising:
the motor control apparatus according to claim 1;
a motor controlled according to a motor power command output from the motor control apparatus; and
a position acquirer configured to acquire a motor position of the motor.
